(19) United States
(12) Patent Application Publication
(10) Pub. No.: US 2026/0257586 A1
(43) Pub. Date: Sep. 3, 2026

(54) SYSTEM FOR MANAGING BATTERIES OF PARKED MACHINES

(71) Applicant: Caterpillar Inc., Peoria, IL (US)

(72) Inventors: Ben Evans, Peoria, IL (US); Dachuan Yu, Dunlap, IL (US)

(73) Assignee: Caterpillar Inc., Peoria, IL (US)

(21) Appl. No.: 19/066,497

(22) Filed: Feb. 28, 2025

(51) Int. Cl. B60L 58/25; B60L 53/66

(52) U.S. Cl. CPC B60L 58/25; B60L 53/66; B60L 2200/40; B60L 2240/545; B60L 2250/16; B60L 2260/22; B60L 2260/58

(57) ABSTRACT

A system for managing a battery pack of a parked machine is disclosed. The system includes one or more electrical energy sources electrically couplable with the battery pack, and a controller. The controller is configured to receive a signal indicative of a temperature of the battery pack. The controller is further configured to control, based on the signal, a transfer of electrical energy between the battery pack and the one or more electrical energy sources to control and maintain the temperature of the battery pack within a pre-defined operating temperature range of the battery pack.

### TECHNICAL FIELD

The present disclosure relates generally to work machines, or vehicles, having battery pack(s). More particularly, the present disclosure relates to managing temperature and/or state-of-charge (SOC) of a battery pack used in a work machine, or vehicle, for example, during periods of non-productive use.

### BACKGROUND

Work machines, or vehicles, for example, wheel loaders, excavators, trucks (e.g., dump trucks, haul trucks, articulated dump trucks, etc.), track-type tractors (i.e., bulldozers), graders, etc., include one or more batteries that may be charged while the machine is not in operation, for example, when parked overnight. Before the machine can be optimally used, the machine often must undergo pre-conditioning procedure(s). The pre-conditioning procedure(s) may include warming the batteries, for example, in cold climate conditions. Warming the one or more batteries is conventionally achieved by drawing power from the batteries to deliver, distribute, and/or pump hot coolant through and around the one or more batteries. An alternate method draws power from the battery to supply heating elements e.g. wires or heating mats that are located between cells or modules in the one or more batteries.

US Application Publication No. 2023/0417564 discloses systems and methods for providing optimized, multi-objective charge planning strategies for electrified vehicles of a vehicle fleet. The proposed systems and methods may utilize a multi-objective approach to charge planning. The multi-objective approach may account for factors such as time, wear, and cost to charge by assigning a cost value to each factor. The proposed systems and methods may further leverage charging at fleet owned/managed depots, public charging stations, and private, residential charging locations when solving the charging path optimization problem for each vehicle of the fleet.

### SUMMARY OF THE INVENTION

In one aspect, the disclosure relates to a system for managing a battery pack of a parked machine. The system includes one or more electrical energy sources electrically couplable with the battery pack, and a controller. The controller configured to receive a signal indicative of a temperature of the battery pack. The controller is further configured to control, based on the signal, a transfer of electrical energy between the battery pack and the one or more electrical energy sources to control and maintain the temperature of the battery pack within a pre-defined operating temperature range of the battery pack.

In another aspect, the disclosure is directed to a control system. The control system includes a control interface configured to receive an information associated with an operation schedule of a parked machine, and a system for managing a battery pack of the parked machine. The system includes one or more electrical energy sources electrically couplable with the battery pack, and a controller in communication with the control interface. The controller is configured to receive a signal indicative of a temperature of the battery pack. In addition, the controller is configured to receive, from the control interface, the information associated with the operation schedule of the parked machine. Further, the controller is configured to control, based on the signal and the information, a transfer of electrical energy between the battery pack and the one or more electrical energy sources to control and maintain the temperature of the battery pack within a pre-defined operating temperature range of the battery pack.

In yet another aspect, the disclosure relates to a method for managing a battery pack of a parked machine. The method includes using one or more electrical energy sources. The one or more electrical energy sources are electrically couplable with the battery pack. The method further includes receiving, by a controller, a signal indicative of a temperature of the battery pack. Furthermore, the method includes controlling, based on the signal, a transfer of electrical energy between the battery pack and the one or more electrical energy sources to control and maintain the temperature of the battery pack within a pre-defined operating temperature range of the battery pack.

### BRIEF DESCRIPTION OF THE DRAWINGS

FIG. 1 is a schematic diagram illustrating an exemplary control system for managing battery packs of parked machine and/or vehicles, in accordance with an embodiment of the present disclosure;

FIG. 2 illustrates a parked machine, in accordance with an embodiment of the present disclosure;

FIG. 3 illustrates an exemplary control interface of the control system, in accordance with an embodiment of the present disclosure; and

FIG. 4 is a flowchart illustrating an exemplary method for managing battery packs of parked machine and/or vehicles, in accordance with an embodiment of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1`, 1``, 101 and 201 could refer to one or more comparable components used in the same and/or different depicted embodiments.

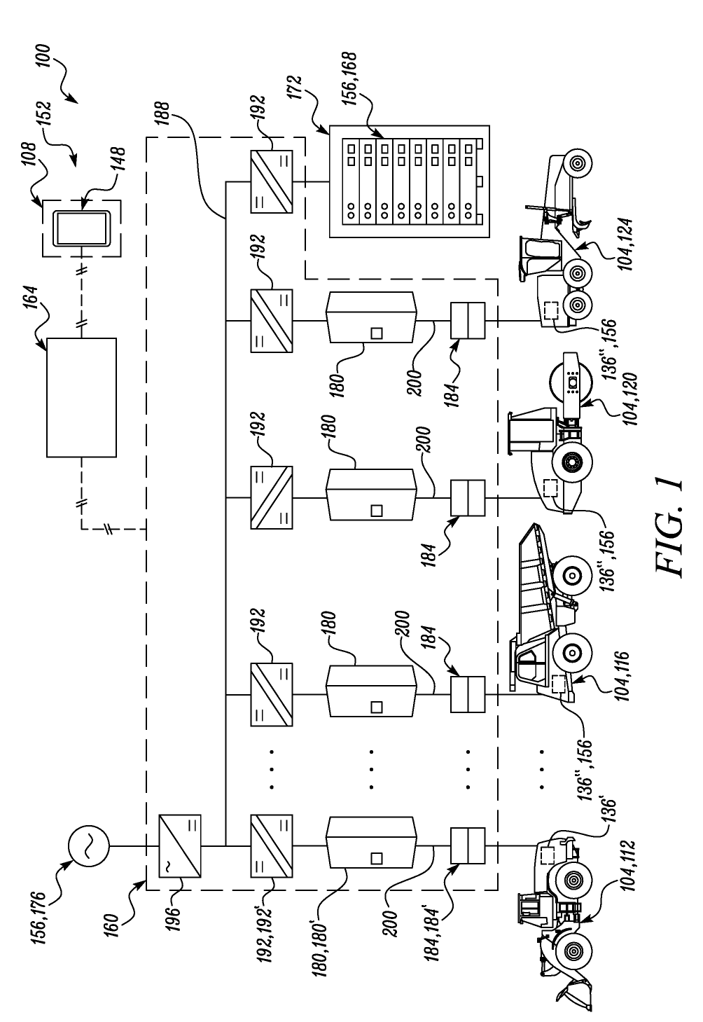

Referring to FIG. 1, a control system 100 is shown. The control system 100 is configured to manage battery packs of machines (or vehicles) 104 located at a worksite, for example, during periods of non-production (e.g., when the machines 104 are parked). The control system 100 may allow operators (or technicians) associated with the machines 104 to remotely (e.g., from a back-office 108) manage the battery packs of machines 104, for example, to make ready the battery packs and the associated machines 104 for operations.

The machines (or vehicles) 104 may cooperatively operate at the worksite to accomplish a variety of tasks. It should be noted that the term “machine” and “vehicle” may be interchangeably used without departing from the meaning and scope of the disclosure. The tasks may be associated with altering geography at the worksite and may include, but are not limited to, dozing tasks, hauling tasks, dumping tasks, loading tasks, grading tasks, compacting tasks, and the like. For explanatory purposes, as shown in FIG. 1, four machines 104, namely a wheel loader 112, a haul truck 116, a motor grader 120, and a compactor 124. For sake of clarity, the wheel loader 112 is hereinafter referred to as “the parked machine” and denoted by identical numeral “112”. Similarly, the haul truck 116 is hereinafter referred to as “the parked vehicle” and denoted by identical numeral “116”, the motor grader 120 is hereinafter referred to as “the parked vehicle” and denoted by identical numeral “120”, and the compactor 124 is hereinafter referred to as “the parked vehicle” and denoted by identical numeral “124”. Further, it may be noted that a number and type of machines 104 operating at the worksite may vary based on the task requirements.

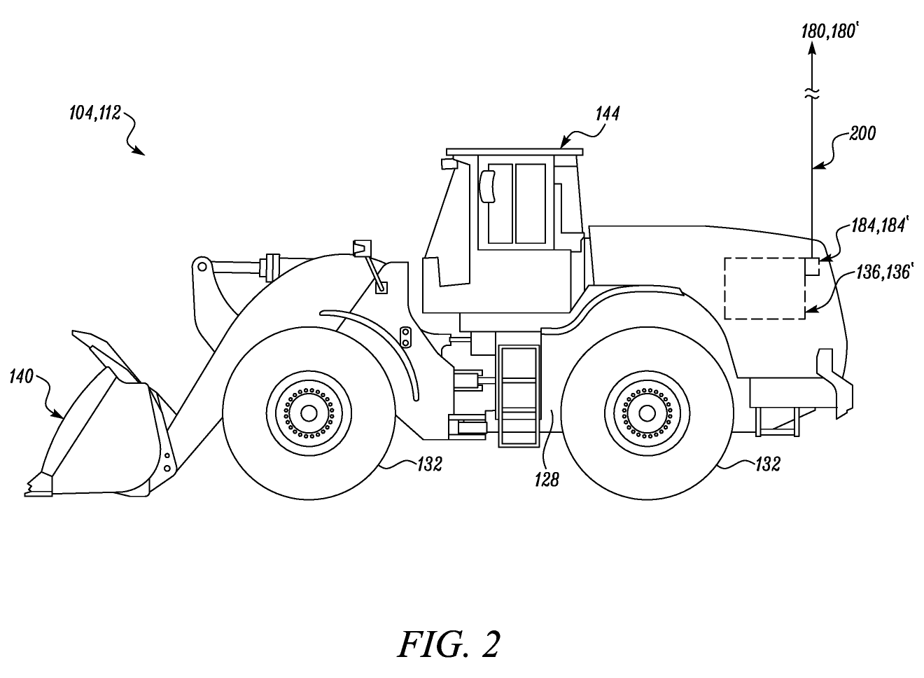

The parked machine 112 is now discussed with reference to FIG. 2. However, it should be noted that the description provided below for the parked machine 112 is equally applicable to the parked vehicles 116, 120, 124, without any limitations. The parked machine 112 may include a main frame 128, ground-engaging members 132, a power source 136, at least one implement 140, and an operator cabin 144. The main frame 128 may support and/or accommodate one or more components/assemblies of the parked machine 112, such as the power source 136, the implement 140 (e.g., bucket 140), and the operator cabin 144, although other known components and structures may be supported by the main frame 128, as well. The ground-engaging members 132 may support the main frame 128 on ground at the worksite.

The power source 136 is a battery pack 136` configured to store, and supply electrical power (e.g., direct electrical current) to the electrical devices and/or components of the parked machine 112. The battery pack 136` may be an onboard battery pack 136`. The battery pack 136` may include energy storage cells (not shown) configured to undergo charging and discharging cycles to respectively store and supply electrical energy. Examples of the energy storage cells may include, but need not be limited to, a lithium-ion cell, such as, a lithium cobalt oxide cell, a lithium manganese oxide cell, a lithium nickel manganese cobalt oxide cell, a lithium iron phosphate cell, a lithium nickel cobalt aluminum oxide cell, and a lithium titanate cell.

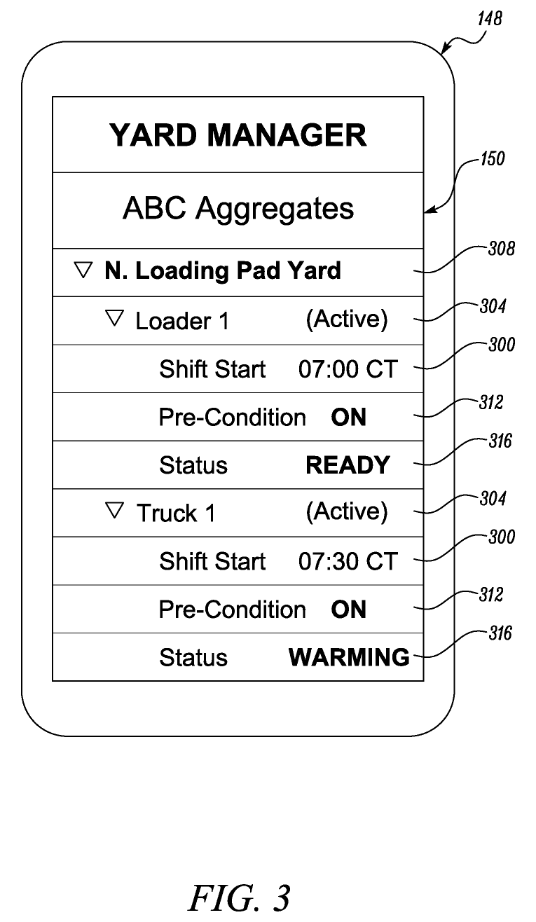

To manage the battery packs of the machines 104, for example, the battery pack 136` of the parked machine 112, the control system 100 includes a control interface 148 and a system 152. The control interface 148 may be located at the back-office 108 (or a remote-control station, or at a personal device of the operator), as shown in FIG. 1. The control interface 148 may include a display device 150 (shown in FIG. 3). The control interface 148 may be configured to receive information associated with an ambient temperature of the worksite. Further, the control interface 148 is configured to receive information associated with the parked machine 112 and the parked vehicles 116, 120, 124. In an example, the control interface 148 is configured to receive an information associated with an operation schedule of the parked machine 112. For instance, the control interface 148 may receive information associated with a shift start time of the parked machine 112, shown as an input tab 300 under a drop-down menu 304 in FIG. 3. The shift start time of the wheel loader 112 may be inserted by an operator associated with the parked machine 112 by accessing the input tab 300.

Further, the control interface 148 may be configured to provide information associated with the status of the parked machine 112 (or the vehicles 116, 120,124). To this end, the display device 150 is configured to display one or more indications, via the notification tabs 312, 316 (as shown in FIG. 3), that the parked machine 112 (and/or the parked vehicles 116, 120, 124) is ready-to-operate or not. For example, the control interface 148, via the notification tab 312, may provide information about the pre-conditioning procedure, e.g., “ON” or “OFF”, as shown in FIG. 3. Further, the control interface 148, via the notification tab 316, may provide information regarding status of the pre-conditioning procedure, e.g., “Ready” or “Warming”, as shown in FIG. 3. Furthermore, the control interface 148 may be configured to provide information indicative of current location of the machines 104 of the worksite, shown as a drop-down menu 308 in FIG. 3. The drop-down menu 308 may include predetermined list of machines 104 present at a particular location of the worksite.

The system 152 enables the control system 100 to control pre-conditioning procedure(s) of the battery pack 136`. The pre-conditioning procedure(s) of the battery pack 136` may include warming the battery pack 136`, for example, in cold climates, before operation. In an embodiment, the system 152 enables the control system 100 to control (e.g., schedule) the pre-conditioning procedure(s) based on temperature of the battery pack 136`. In one example, the system 152 may determine the temperature of the battery pack 136` based on an ambient temperature of the worksite. In another example, the system 152 may determine the temperature of the battery pack 136` directly from a temperature sensor associated with the battery pack 136`. In addition, the system 152 may enable the control system 100 to control (e.g., schedule) the pre-conditioning procedure(s) of the battery pack 136` based on an operation schedule of the parked machine 112.

Continuing with FIG. 1, the system 152 includes one or more electrical energy sources 156, a bi-directional charging circuit 160, and a controller 164. Each of the electrical energy sources 156, the bi-directional charging circuit 160, and the controller 164 is now discussed in detail below.

The electrical energy sources 156 may be any type of device operable to store electrical energy and exchange the electrical energy with (i.e., receive electrical energy from and transmit electrical energy to) the battery pack 136`. In one example, the electrical energy sources 156 may include one or more on-board battery packs 136`` associated with at least one of the parked vehicles 116, 120, 124. In another example, the electrical energy sources 156 may include one or more batteries 168 (or fuel cells, or capacitors) associated with an energy storage system (ESS) 172. In yet another example, the electrical energy sources 156 may include an alternate current supply source 176.

The bi-directional charging circuit 160 is configured to electrically couple the one or more electrical energy sources 156 with the battery pack 136` (of the parked machine 112). To this end, the bi-directional charging circuit 160 may extend between the battery pack 136` (of the parked machine 112) and the one or more electrical energy sources 156 to electrically couple the one or more electrical energy sources 156 with the battery pack 136`. The bi-directional charging circuit 160 may operate in a first mode and a second mode. In an example in which the bi-directional charging circuit 160 operates in the first mode, the bi-directional charging circuit 160 may transfer the electrical energy from the battery pack 136` to the one or more electrical energy sources 156 to discharge the battery pack 136`. In an example in which the bi-directional charging circuit 160 operates in the second mode, the bi-directional charging circuit 160 may transfer the electrical energy from the one or more electrical energy sources 156 to the battery pack 136` to charge the battery pack 136`.

The bi-directional charging circuit 160 may include one or more charging units 180, one or more charger couplings 184, a direct current bus 188 (hereinafter referred to as “DC bus 188”), one or more DC-to-DC converters 192, and one or more AC-to-DC converters 196. The charging unit 180` of the one or more charging units 180 is now discussed in detail with reference to FIG. 1. However, it should be noted that the description provided below for the charging unit 180` is equally applicable to other charging units 180 as well. The charging unit 180` may be a portable charger assembly (i.e., movable around the worksite), or may be a permanently positioned charger assembly. The charging unit 180` may be a bi-directional charging unit 180` that is configured to allow transfer of the electrical energy to and from the battery pack 136` (of the parked machine 112) to correspondingly charge (i.e., in the second mode) and discharge (i.e., in the first mode) the battery pack 136`. In one or more aspect, the charging unit 180` itself may be charged or otherwise powered via one or more connections to a power grid, generators or gensets, solar panels, wind turbines or wind power sources, hydroelectric sources, other power source (e.g., a source of alternating current or direct current). The charging unit 180` may include one or more internal batteries. The charging unit 180` may be electrically coupled to the battery pack 136` (of the parked machine 112), for example, via a conductor 200.

The charger couplings 184 may be configured to electrically connect the charging units 180 with their corresponding battery packs 136`, 136``. The charger coupling 184` electrically connecting the charging unit 180` with the corresponding battery pack 136` (of the parked machine 112) is now discussed in detail with reference to FIG. 2. The charger coupling 184` may be configured to receive a mounting portion 204 of the conductor 200 to electrically connect the charging unit 180`with the battery pack 136`. In an example, the charger coupling 184` and the mounting portion 204 (of the conductor 200) may form a snap-fit connection therebetween. It should be noted that the description provided above for the charger coupling 184` is equally applicable to other charger couplings 184 electrically connecting the associated charging units 180 with the corresponding battery packs 136`` of the parked vehicles 116, 120, 124.

The DC bus 188 may be an electrical bus that is configured to transmit electrical energy (e.g., DC electrical energy) between one or more components connected to the DC bus 188. The DC bus 188 may be electrically connected to the charging units 180 via the corresponding DC-to-DC converters 192. In an example, as shown in FIG. 1, the DC bus 188 is electrically connected to the charging unit 180` via the corresponding DC-to-DC converter 192`. Further, in addition to this, the DC bus 188 may be electrically connected to the alternate current supply source 176 via the AC-to-DC converter 196, as shown in FIG. 1.

The DC-to-DC converters 192 may be configured to convert direct current (DC), for example, received from the one or more electrical energy sources 156 (and/or the battery pack 136`) from one voltage level to another voltage level. Each of the DC-to-DC converters 192 may be capable of bi-directional power flow. This means that the DC-to-DC converter 192 may operate in both directions, converting a DC power of first voltage level to a DC power of second voltage level when the flow of power is in one direction (e.g., to charge the battery packs 136`, 136``, in the second mode), and converting the DC power of the second voltage level to the DC power of the first voltage level when the flow of power is in the opposite direction (e.g., to discharge the battery packs 136`, 136``, in the first mode).

The AC-to-DC converters 196 may be capable of bi-directional power flow. This means that the AC-to-DC converters 196 may operate in both directions, converting AC power to DC power when the flow of power is in one direction (e.g., to charge the battery packs 136`, 136``, in the second mode), and converting DC power to AC power when the flow of power is in the opposite direction (e.g., to discharge the battery packs 136`, 136``, in the first mode).

The controller 164 is now discussed. The controller 164 is configured to receive an information (or signal) indicative of the temperature of the battery pack 136` (of the parked machine 112). To this end, the controller 164 may be in communication with a battery temperature sensor (not shown) positioned on or within the battery pack 136`. The battery temperature sensor may sense the temperature of the battery pack 136`, generate a signal indicative of the temperature of the battery pack 136`, and transmit the signal to the controller 164.

Further, the controller 164 may be communicably coupled with the control interface 148. In an embodiment in which the control interface 148 may collect updated information related to an ambient environment of the worksite (or the parked machine 112), for example, from internet, the controller 164 may determine the temperature of the battery pack 136` based on the updated information related to the ambient environment of the worksite (or the parked machine 112) received from the control interface 148.

Based on the information (or signal) indicative of the temperature of the battery pack 136`, the controller 164 is configured to control a transfer of electrical energy between the battery pack 136` and the one or more electrical energy sources 156 to control and maintain the temperature of the battery pack 136` within a pre-defined operating temperature range of the battery pack 136`. The pre-defined operating temperature range of the battery pack 136` may be pre-stored in a memory of the controller 164.

For example, upon receipt of the signal (from the battery temperature sensor) indicative of the temperature of the battery pack 136`, the controller 164 may determine if the temperature of the battery pack 136` is within the pre-defined operating temperature range. Upon determining the temperature to be lower than the pre-defined operating temperature range, the controller 164 may control the bi-directional charging circuit 160 to operate in the first mode and the second mode to correspondingly discharge and charge the battery pack 136` until the temperature of the battery pack 136` is raised to a value within the pre-defined operating temperature range of the battery pack 136`.

Additionally, the controller 164 may be configured to receive information (hereinafter referred to as “first information”) associated with the operation schedule of the parked machine 112. The controller 164 may receive the first information, as an input, from the control interface 148. The first information may include, but not limited to, a shift start time, shift end time, shift start location, shift end location, and the like. Based on the first information and the signal indicative of the temperature, the controller 164 may control the transfer of electrical energy between the battery pack 136` and the one or more electrical energy sources 156. That is, the controller 164 may determine a rate of electrical energy transfer between the battery pack 136` and the one or more electrical energy sources 156 based on the temperature and the first information associated with the operation schedule of the parked machine 112.

In an example, the controller 164 may determine a direct current internal resistance of the battery pack 136` based on the signal indicative of the temperature of the battery pack 136` (e.g., by utilizing a map correlating the temperature of the battery pack 136` with prestored direct current internal resistance values). Based on the direct current internal resistance value and the operation schedule of the parked machine 112, the controller 164 may control (raise, or lower, or maintain) the rate of electrical energy transfer between the battery pack 136` and the one or more electrical energy sources 156. For instance, the controller 164 may set a first electrical energy transfer rate when a time difference between the current time and the shift start time is high (e.g., when the battery pack 136` is to be warmed-up in a long duration), whereas the controller 164 may set a second electrical energy transfer rate higher than the first electrical energy transfer rate when a time difference between the current time and the shift start time is low (e.g., when the battery pack 136` is to be warmed-up in a short duration).

Further, in an embodiment, the controller 164 may be configured to receive an information (hereinafter referred to as “second information”) associated with one or more operation schedules of the one or more parked vehicles, e.g., the parked vehicles 116, 120, 124 (as shown in embodiment of FIG. 1). The controller 164 may receive the second information, as an input, from the control interface 148. The second information may include, but not limited to, a shift start time, shift end time, shift start location, shift end location, and the like.

Examples of the memory (of the controller 164) may include a hard disk drive (HDD), and a secure digital (SD) card. Further, the memory may include non-volatile/volatile memory units such as a random-access memory (RAM) / a read only memory (ROM), which may include associated input and output buses. The memory may be configured to store various other instruction sets, datasets, for various other functions of the control system 100, along with the set of instruction, datasets, discussed above.

The controller 164 may include a processor to process a variety of data (or inputs) such as the temperature data, operation schedule data, and the like. Examples of the processor may include, but are not limited to, an X86 processor, a Reduced Instruction Set Computing (RISC) processor, an Application Specific Integrated Circuit (ASIC) processor, a Complex Instruction Set Computing (CISC) processor, an Advanced RISC Machine (ARM) processor, or any other processor.

Further, the controller 164 may include a transceiver. According to various embodiments of the present disclosure, the transceiver may enable the controller 164 to communicate (e.g., wirelessly) with the control interface 148 and the bi-directional charging circuit 160, etc., over one or more of wireless radio links, infrared communication links, short wavelength ultra-high frequency radio waves, short-range high frequency waves, or the like. Example transceivers may include, but not limited to, wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, and wired local area network (LAN) Ethernet transceivers for network data communication.

### INDUSTRIAL APPLICABILITY

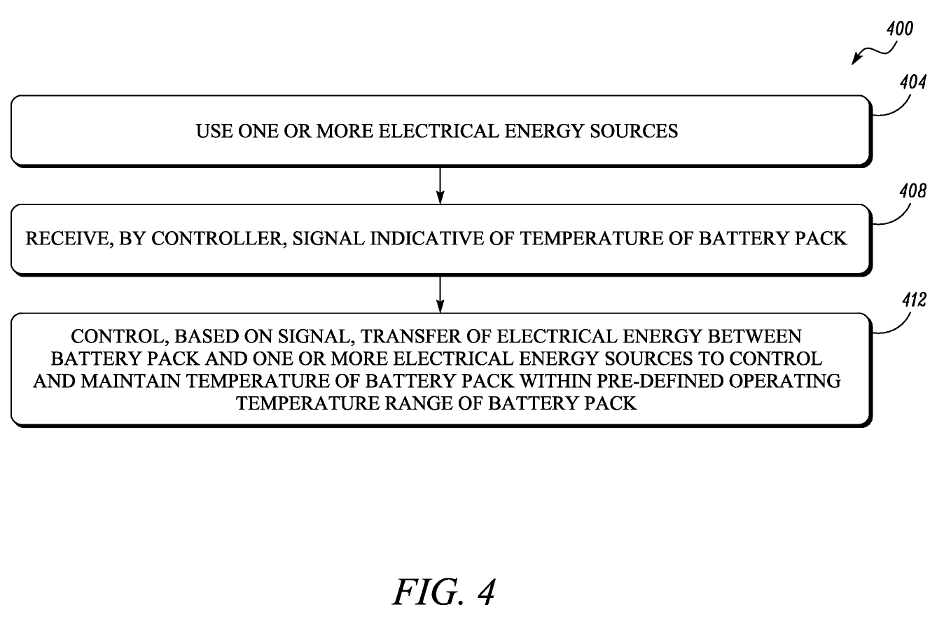

Referring to FIG. 4, an example method for managing a battery pack of a parked machine, for example, the battery pack 136` of the parked machine 112, is discussed. The method discussed by way of a flowchart 400 that illustrates exemplary stages (e.g., from 404 to 412) associated with the method. The method is also discussed in conjunction with FIGS. 1-3. It will be appreciated that the description in the method is exemplary in nature and that the steps can be performed in different executable details than what is set out below, as will be contemplated by a person skilled in the art based on the description of the present disclosure.

The method includes using one or more electrical energy sources 156 (e.g., on-board battery packs 136`, batteries 168 of the ESS 172, the alternate current supply source 176) of the system 152 for managing the battery pack 136` (e.g., controlling the temperature, or state-of-charge, of the battery pack 136`) (STEP 404). To this end, the one or more electrical energy sources 156 (e.g., the on-board battery pack 136`` of the parked vehicle 116) and the battery pack 136` (of the parked machine 112) are electrically coupled, for example, by the bi-directional charging circuit 160. The bi-directional charging circuit 160 is configured to operate in the first mode and the second mode. When operating in the first mode, the bi-directional charging circuit 160 enables transfer of the electrical energy from the battery pack 136` to the one or more electrical energy sources 156 to discharge the battery pack 136`. When operating in the second mode, the bi-directional charging circuit 160 enables transfer of the electrical energy from the one or more electrical energy sources 156 to the battery pack 136` to charge the battery pack 136`.

The method further includes receiving, by the controller 164, a signal indicative of a temperature of the battery pack 136` (STEP 408). To this end, the controller 164 may receive the signal indicative of the temperature of the battery pack 136` from the battery temperature sensor positioned on or within the battery pack 136`. In an alternate embodiment, the controller 164 may receive information related to the ambient environment of the worksite (or the parked machine 112) from the control interface 148, and determine the temperature of the battery pack 136` based on the updated information related to the ambient environment of the worksite (or the parked machine 112).

Further, the method includes controlling, based on the signal indicative of the temperature of the battery pack 136`, the transfer of electrical energy between the battery pack 136` and the one or more electrical energy sources 156 to control and maintain the temperature of the battery pack 136` within a pre-defined operating temperature range (prestored in the memory of the controller 164) of the battery pack 136` (STEP 412). For instance, the controller 164 may compare a value of temperature received with maximum and minimum allowable temperature values associated with the pre-defined operating temperature range of the battery pack 136`. Based on the comparison, the controller 164 may determine if the temperature of the battery pack 136` is within the pre-defined operating temperature range. For example, upon determining the temperature to be lower than the pre-defined operating temperature range, the controller 164 may control the bi-directional charging circuit 160 to alternately operate in the first mode and the second mode to correspondingly discharge and charge the battery pack 136`. As the battery pack 136` undergoes charging and discharging cycles (e.g., partial charging/discharging cycles), the energy storage cells (of the battery pack 136`) generate heat, for example, due to internal electrical resistances, due to which the temperature of the battery pack 136` is raised.

Once the temperature of the battery pack 136` is raised to a value within the pre-defined operating temperature range, the controller 164 may control (e.g., vary) the rate of energy transfer between the battery pack 136` and the one or more electrical energy sources 156 to maintain the temperature of the battery pack 136` within the pre-defined operating temperature range, for example, until the shift start time of the parked machine 112.

Additionally, in an embodiment, the controller 164 may receive the first information (e.g., the shift start time, shift start location, etc.) associated with the operation schedule of the parked machine 112, for example, from the control interface 148. Based on the first information and the signal indicative of the temperature, the controller 164 may control the transfer of electrical energy between the battery pack 136` and the one or more electrical energy sources 156. For instance, the controller 164 may set a relatively higher electrical energy transfer rate if the parked machine 112 is to be prepared for operation within a short time span (i.e., when a time difference between the current time and the shift start time is low), whereas the controller 164 may set a relatively lower electrical energy transfer rate if the parked machine 112 is to be prepared for operation in a long time span (i.e., when a time difference between the current time and the shift start time is high).

In further embodiments, the controller 164 may also consider the second information (e.g., the shift start time, shift start location, etc.) associated with one or more operation schedules of the one or more parked vehicles, e.g., the parked vehicles 116, 120, 124, to control the electrical energy transfer between the battery pack 136` (of the parked machine 112) and the one or more electrical energy sources 156 (e.g., the battery pack 136`` of the parked vehicle 116). In an exemplary operating scenario in which the operation sequence is defined as: the parked machine 112 will start first, followed by the parked vehicle 116, the controller 164 may set a relatively lower electrical energy transfer rate for the parked vehicle 116 having a larger time difference between the current time and the shift start time, than an electrical energy transfer rate for the parked machine 112 having a lower difference between the current time and the shift start time.

The disclosed aspects of control system 100, and the system 152, may be used to help initiate one or more pre-conditioning procedures (e.g., warming procedures) to assist in the operation of the machine or vehicle 104. The one or more pre-conditioning procedures may be initiated while the machine or vehicle 104 is parked and coupled to their corresponding charging units 180 (or other power sources). Further, initiating the pre-conditioning procedure of the parked machines or vehicles 104, based on the temperature of their corresponding battery packs (or the ambient temperature of the worksite) and/or the operation schedules of the parked machines 104, may result in the battery packs being heated to their corresponding pre-defined operating temperature ranges for the machines or vehicles 104 to be ready-to-work on their scheduled shift start time.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word "or" refers to any possible permutation of a set of items. For example, the phrase "A, B, or C" refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the system, the control system, and the method of the present disclosure without departing from the scope of the disclosure. Other embodiments will be apparent to those skilled in the art from consideration of the specification and practice of the enclosure, the system, the control system, and the method disclosed herein. It is intended that the specification and examples be considered as exemplary only, with a true scope of the disclosure being indicated by the following claims and their equivalent.

What is claimed is:

1. A system for managing a battery pack of a parked machine, the system comprising:
one or more electrical energy sources electrically couplable with the battery pack; and
a controller configured to:
receive a signal indicative of a temperature of the battery pack; and
control, based on the signal, a transfer of electrical energy between the battery pack and the one or more electrical energy sources to control and maintain the temperature of the battery pack within a pre-defined operating temperature range of the battery pack.

2. The system of claim 1 further including a bi-directional charging circuit extending between the battery pack and the one or more electrical energy sources to electrically couple the battery pack with the one or more electrical energy sources, the bi-directional charging circuit is configured to operate in a first mode and a second mode, wherein the controller is configured to control the bi-directional charging circuit to operate:
in the first mode to transfer the electrical energy from the battery pack to the one or more electrical energy sources to discharge the battery pack; and
in the second mode to transfer the electrical energy from the one or more electrical energy sources to the battery pack to charge the battery pack.

3. The system of claim 1, wherein the controller is configured to:
receive a first information associated with an operation schedule of the parked machine; and
control the transfer of electrical energy between the battery pack and the one or more electrical energy sources based on the first information.

4. The system of claim 3, wherein the controller is configured to:
determine a direct current internal resistance of the battery pack based on the signal indicative of the temperature of the battery pack; and
control a rate of electrical energy transfer between the battery pack and the one or more electrical energy sources based on the direct current internal resistance to control and maintain the temperature of the battery pack within the pre-defined operating temperature range.

5. The system of claim 1, wherein the one or more electrical energy sources include one or more on-board battery packs of one or more parked vehicles.

6. The system of claim 5, wherein the controller is configured to:
receive a first information associated with an operation schedule of the parked machine;
receive a second information associated with one or more operation schedules of the one or more parked vehicles; and
control the transfer of electrical energy between the battery pack of the parked machine and the one or more on-board battery packs of the one or more parked vehicles based on the first information and the second information.

7. The system of claim 1, wherein the one or more electrical energy sources include one or more batteries associated with an energy storage system.

8. The system of claim 1, wherein the one or more electrical energy sources includes an alternate current supply source.

9. A control system, comprising:
a control interface configured to receive an information associated with an operation schedule of a parked machine; and
a system for managing a battery pack of the parked machine, the system including:
one or more electrical energy sources electrically couplable with the battery pack; and
a controller in communication with the control interface, the controller is configured to:
receive a signal indicative of a temperature of the battery pack;
receive, from the control interface, the information associated with the operation schedule of the parked machine; and
control, based on the signal and the information, a transfer of electrical energy between the battery pack and the one or more electrical energy sources to control and maintain the temperature of the battery pack within a pre-defined operating temperature range of the battery pack.

10. The control system of claim 9, wherein the control interface includes a display device configured to display one or more indications that the parked machine is ready-to-operate once the temperature of the battery pack is within the pre-defined operating temperature range.

11. The control system of claim 9, wherein the system includes a bi-directional charging circuit extending between the battery pack and the one or more electrical energy sources to electrically couple the battery pack with the one or more electrical energy sources, the bi-directional charging circuit is configured to operate in a first mode and a second mode, wherein the controller is configured to control the bi-directional charging circuit to operate:
in the first mode to transfer the electrical energy from the battery pack to the one or more electrical energy sources to discharge the battery pack; and
in the second mode to transfer the electrical energy from the one or more electrical energy sources to the battery pack to charge the battery pack.

12. The control system of claim 9, wherein the controller is configured to:
determine a direct current internal resistance of the battery pack based on the signal indicative of the temperature of the battery pack; and
control a rate of electrical energy transfer between the battery pack and the one or more electrical energy sources based on the direct current internal resistance to control and maintain the temperature of the battery pack within the pre-defined operating temperature range.

13. The control system of claim 9, wherein the one or more electrical energy sources include one or more on-board battery packs of one or more parked vehicles.

14. The control system of claim 13, wherein the information associated with the operation schedule of the parked machine is a first information, and wherein the controller is configured to:
receive a second information associated with one or more operation schedules of the one or more parked vehicles; and
control the transfer of electrical energy between the battery pack of the parked machine and the one or more on-board battery packs of the one or more parked vehicles based on the first information and the second information.

15. The control system of claim 9, wherein the one or more electrical energy sources include at least one of one or more batteries associated with an energy storage system and an alternate current supply source.

16. A method for managing a battery pack of a parked machine, the method comprising:
using one or more electrical energy sources, the one or more electrical energy sources being electrically couplable with the battery pack;
receiving, by a controller, a signal indicative of a temperature of the battery pack; and
controlling, based on the signal, a transfer of electrical energy between the battery pack and the one or more electrical energy sources to control and maintain the temperature of the battery pack within a pre-defined operating temperature range of the battery pack.

17. The method of claim 16 further including:
receiving, by the controller, a first information associated with an operation schedule of the parked machine; and
controlling the transfer of electrical energy between the battery pack and the one or more electrical energy sources based on the first information.

18. The method of claim 17, wherein controlling the electrical energy transfer between the battery pack and the one or more electrical energy sources includes:
determining a direct current internal resistance of the battery pack based on the signal indicative of the temperature of the battery pack; and
controlling a rate of electrical energy transfer between the battery pack and the one or more electrical energy sources based on the direct current internal resistance to control and maintain the temperature of the battery pack within the pre-defined operating temperature range.

19. The method of claim 16, wherein the one or more electrical energy sources include one or more on-board battery packs of one or more parked vehicles, the method including:
receiving, by the controller, a first information associated with an operation schedule of the parked machine;
receiving, by the controller, a second information associated with one or more operation schedules of the one or more parked vehicles; and
controlling the transfer of electrical energy between the battery pack of the parked machine and the one or more on-board battery packs of the one or more parked vehicles based on the first information and the second information.

20. The method of claim 16, wherein the one or more electrical energy sources include at least one of one or more batteries associated with an energy storage system and an alternate current supply source.
